(19) United States
(12) Patent Application Publication
(10) Pub. No.: US 2026/0303418 A1
(43) Pub. Date: Oct. 1, 2026

(54) Systems and Methods for Communicating using Time Shift Signaling

(71) Applicant: TeraSignal LLC, Newport Coast, CA (US)

(72) Inventors: Armond Hairapetian, Newport Coast, CA (US); Wim Cops, Newport Coast, CA (US)

(73) Assignee: TeraSignal LLC, Newport Coast, CA (US)

(21) Appl. No.: 19/635,341

(22) Filed: Mar. 31, 2026

Related U.S. Application Data
(60) Provisional application No. 63/781,213, filed on Mar. 31, 2025.

(51) Int. Cl. H04L 25/49

(52) U.S. Cl. CPC H04L 25/4917

(57) ABSTRACT

Systems and methods that utilize time shift signaling are disclosed. In a number of embodiments, communicating via time shift signaling involves receiving N bits and generating a symbol of period T with respect to each of the N bits, wherein each sequential symbol is time delayed by T/N. The time delayed symbols are summed, wherein the sum is equal to a number of superimposed symbols sharing a same binary value. The sum can then be provided to a digital-to-analog converter, and an output of the digital-to-analog converter is provided to a linear driver to generate a transmitted analog signal. The transmitted analog signal can be received via a communication channel, and time delayed versions of the received analog signal are digitized. Inter-symbol interference (ISI) cancellation can then be performed to estimate each of the time shifted symbols.

### CROSS-REFERENCE TO RELATED APPLICATIONS

The current application claims priority under 35 U.S.C. 119(e) to U.S. Provisional Patent Application Ser. No. 63/781,213, entitled “Systems and Methods for Communicating using Time Shift Signaling”, filed Mar. 31, 2025. The disclosure of U.S. Provisional Patent Application No. 63/781,213 is hereby incorporated by reference in its entirety for all purposes.

### FIELD OF THE INVENTION

The present invention generally relates to methods of signaling between integrated circuits and more specifically to transmitters and receivers that communicate via time shift (TS) signaling.

### BACKGROUND

Emerging, data-intensive technologies like artificial intelligence and machine learning are driving demand for technologies that enable faster data transfer between computers. In the last decade, multiple innovations have been developed to increase the data transfer rates that can be achieved within computer networks, including moving from electrical to optical cables and employing higher data rate signaling techniques such as four-level pulse amplitude-modulated signaling (PAM4) in place of binary signaling techniques such as non-return to zero (NRZ) signaling.

At the physical layer, traditional NRZ signaling techniques running through electrical channels like PCB traces and server interconnects can experience a bandwidth limit at around 25 Gb/s. The faster a signal transmits through a channel, the more it is affected by signal integrity issues, which can limit the channel's bandwidth, distorting the signal with noise, jitter, and other impairments that make the signal more difficult for the receiver to interpret. The channel insertion loss can become too high at this frequency to maintain a recoverable bit error rate.

In order to increase data rates, standards such as the IEEE 802.3bs standard adopted higher cardinality modulation schemes such PAM4. Pulse amplitude modulation encodes data across multiple voltage levels. PAM4 uses four levels. A PAM4 signal can appear as one of four voltages during each clock cycle, each voltage level representing two bits of data rather than a single bit like an NRZ-encoded signal.

The most significant advantage of PAM4 is the increase in data rate. The data rate of a PAM4 signal is equal to twice the baud rate, or symbol rate. In PAM4, each symbol contains two bits. Therefore, a PAM4 signal can theoretically transmit twice as much data without increasing the transmitter's baud rate or losing the signal to insertion loss. With this advantage comes the need for fewer lanes in optical transceivers, cables, and interconnects compared to the use of NRZ signaling to achieve the same data rate. PAM4 signals, however, tend to be more susceptible to noise than NRZ signals transmitted with the same power. Noise or timing jitter in a PAM4 signal is more likely to cause the voltage of the received signal to fall within a range that does not correspond to the transmitted signal.

Error rates in PAM4 signals can be reduced using filtering, such as decision feedback equalization (DFE), and/or implementing forward error correction (FEC). FEC adds redundant data to serial bitstreams by encoding the transmitted data using error-correcting codes that can enable the receiver to reconstruct the data accurately, reducing bit error rate.

### SUMMARY OF INVENTION

Systems and methods in accordance with various embodiments of the invention provide communication using time shift (TS) signaling. In many embodiments, a method of TS signaling is utilized in which each bit corresponds to a symbol having a time period T, and at any given time, the transmitted signal is the superposition of N symbols. The superposition of the N symbols is achieved by transmitting each of the N symbols of period T sequentially with spacing of T/N between consecutive bits, allowing N bits to be transmitted per time interval T using a signal having N+1 voltage levels. By contrast, a system utilizing PAM requires 2^{N} voltage levels to transmit the same number of bits at a baud rate of 1/T symbols per second. In many instances, TS signaling allows trading off timing information for bits per symbol in a linear fashion, and compared to PAM, TS signaling utilizes a lower transmission bandwidth for a given data rate or can achieve a higher data rate at a given bandwidth. TS signaling may be utilized in one dimension or in combination with multi-dimensional modulation schemes including Quadrature Amplitude Modulation (QAM) and Phase Shift Keying (PSK). In various embodiments, TS signaling is implemented within linear transceivers within integrated circuits that may be incorporated within servers, memories, switches, routers, transport equipment, and other types of devices employed in data communication systems. The signal path between integrated circuits may be single-ended or differential, DC coupled or AC coupled through capacitors, and may be formed using conductive wires such as copper, fiber optics, wireless connections, capacitive or inductive coupling, or other suitable media.

TS encoders in accordance with various embodiments generate symbols for each bitstream that are equalized to account for channel impairments, where each bitstream may be equalized at the transmitter for a given channel as if the bitstream was an independent single channel. TS receivers may sample the transmitted analog signal using N sample and hold circuits delayed from each other by T/N, and depending on the impairments of the channel, the received signals may require equalization before being processed by a TS (Inter-Symbol Interference) ISI canceller, with equalization being accomplished in the analog domain for benign channels or using digital equalizers for severe channels having large ISI and reflection.

In one embodiment, a transmitter capable of communicating via time shift signaling comprises interface circuitry capable of receiving data from a serializer-deserializer (SERDES) circuit; a TS encoder capable of receiving a series of N bits from the interface circuitry, where the TS encoder comprises a plurality of separate encoder and transmit equalizers including at least a first encoder and transmit equalizer capable of producing a digital representation of a first symbol having a time period T based upon a first bit of the series of N bits, a second encoder and transmit equalizer capable of producing a digital representation of a second symbol having a time period T based upon a second bit of the series of N bits where the second symbol is time delayed by a period of T/N relative to the first symbol, and a third encoder and transmit equalizer capable of producing a digital representation of a third symbol having a time period T based upon a third bit of the series of N bits where the third symbol is time delayed by a period of T/N relative to the second symbol; a summing circuit capable of summing each of the N symbols output by the separate encoder and transmit equalizers at each T/N time interval during the symbol time period T of the first symbol to produce a series of summed values; a digital-to-analog converter capable of producing an analog waveform based upon the series of summed values; and a driver circuit capable of generating a signal on a communication channel based upon the analog waveform.

In a further embodiment, the communication channel is single-ended or differential.

In another embodiment, the communication channel is DC coupled or AC coupled through capacitors.

In a still further embodiment, the communication channel comprises at least one of conductive wires, fiber optics, and a wireless connection.

In still another embodiment, the plurality of separate encoder and transmit equalizers further includes a fourth encoder and transmit equalizer capable of producing a digital representation of a fourth symbol having a time period T based upon a fourth bit of the series of N bits, where the fourth symbol is time delayed by a period of T/N relative to the third symbol.

In a yet further embodiment, each of the plurality of separate encoder and transmit equalizers is configured to equalize its respective bitstream for a given channel as if the bitstream was an independent single channel.

In yet another embodiment, the analog waveform has N+1 possible voltage levels, where N bits are transmitted per time interval T.

In a further additional embodiment, at the end of the symbol time period T of the first symbol, a new series of bits is provided as inputs to the encoder and transmit equalizers, and at time T+T/N, the sum provided to the digital-to-analog converter is the sum of the digital representations of the time delayed versions of symbols S₁, . . . , S_{N-1} and a newly generated representation of symbol S_{N} based upon bit B_{N}, excluding the contribution from symbol S₀.

In another additional embodiment, a receiver capable of receiving data transmitted via time shift (TS) signaling comprises interface circuitry capable of transmitting data to a serializer-deserializer (SERDES) circuit; a TS decoder capable of receiving an analog signal via a communication channel and outputting a series of recovered bits to the interface circuitry, where the TS decoder comprises N sample and hold circuits that are each delayed from each other by a time period T/N; N analog-to-digital converters (ADCs), where each of the N sample and hold circuits is capable of providing an output to a corresponding ADC; N receiver equalizers, where each of the N ADCs is capable of providing an output to a corresponding receiver equalizer; a TS Inter-Symbol Interference (ISI) canceller and a Decision Feedback Equalizer (DFE) equalizer, where each of the N receiver equalizers provides an output to the TS ISI canceller and DFE equalizer and the TS ISI canceller and DFE equalizer utilizes samples at intervals of N/T from each of the outputs provided by the N receiver equalizers to generate output symbols; and a decoder, where the TS ISI canceller and DFE equalizer is capable of providing the generated output symbols to the decoder and the decoder generates the series of recovered bits based upon the provided output symbols.

In a still yet further embodiment, the N receiver equalizers are digital equalizers that remove ISI and reflections introduced by the communication channel.

In a still yet another embodiment, depending on impairments of the communication channel, the received analog signal requires equalization before being processed by the TS ISI canceller.

In one further embodiment, for benign channels, equalization is accomplished by processing signals in the analog domain.

In one additional embodiment, for severe channels having large ISI and reflection, the output of each of the N sample and hold circuits is provided to a separate ADC, followed by N digital equalizers which remove the ISI introduced by the channel.

In a further embodiment, a linear transceiver capable of communicating via time shift (TS) signaling comprises interface circuitry capable of transmitting and receiving data to and from a serializer-deserializer (SERDES) circuit; a TS encoder capable of receiving a series of N bits from the interface circuitry, where the TS encoder comprises a plurality of separate encoder and transmit equalizers including at least a first encoder and transmit equalizer capable of producing a digital representation of a first symbol having a time period T based upon a first bit of the series of N bits, a second encoder and transmit equalizer capable of producing a digital representation of a second symbol having a time period T based upon a second bit of the series of N bits where the second symbol is time delayed by a period of T/N relative to the first symbol, and a third encoder and transmit equalizer capable of producing a digital representation of a third symbol having a time period T based upon a third bit of the series of N bits where the third symbol is time delayed by a period of T/N relative to the second symbol; a summing circuit capable of summing each of the N symbols output by the separate encoder and transmit equalizers at each T/N time interval during the symbol time period T of the first symbol to produce a series of summed values; a digital-to-analog converter capable of producing an analog waveform based upon the series of summed values; and a driver circuit capable of generating a signal on a first communication channel based upon the analog waveform; a TS decoder capable of receiving an analog signal via a second communication channel and outputting a series of recovered bits to the interface circuitry, where the TS decoder comprises N sample and hold circuits that are each delayed from each other by a time period T/N; N analog-to-digital converters (ADCs), where each of the N sample and hold circuits is capable of providing an output to a corresponding ADC; N receiver equalizers, where each of the N ADCs is capable of providing an output to a corresponding receiver equalizer; a TS Inter-Symbol Interference (ISI) canceller and a Decision Feedback Equalizer (DFE) equalizer, where each of the N receiver equalizers provides an output to the TS ISI canceller and DFE equalizer and the TS ISI canceller and DFE equalizer utilizes samples at intervals of N/T from each of the outputs provided by the N receiver equalizers to generate output symbols; and a decoder, where the TS ISI canceller and DFE equalizer is capable of providing the generated output symbols to the decoder and the decoder generates the series of recovered bits based upon the provided output symbols.

In another embodiment, an integrated circuit capable of communicating via time shift (TS) signaling comprises a serializer-deserializer (SERDES) circuit; circuits coupled to the SERDES circuit, where the SERDES is capable of transmitting and receiving parallel data to and from the circuits coupled to the SERDES circuit; a linear transceiver, where the linear transceiver is capable of transmitting and receiving high-speed serial data to and from the SERDES circuit; wherein the linear transceiver comprises interface circuitry capable of transmitting and receiving data to and from the serializer-deserializer (SERDES) circuit; a TS encoder capable of receiving a series of N bits from the interface circuitry; a summing circuit capable of summing each of the N symbols output by the separate encoder and transmit equalizers at each T/N time interval during the symbol time period T of the first symbol to produce a series of summed values; a digital-to-analog converter capable of producing an analog waveform based upon the series of summed values; a driver circuit capable of generating a signal on a first communication channel based upon the analog waveform; and a TS decoder capable of receiving an analog signal via a second communication channel and outputting a series of recovered bits to the interface circuitry.

In a still further embodiment, a method of transmitting data via time shift signaling comprises receiving a series of N bits from a serializer-deserializer (SERDES) circuit; producing N symbols based upon the series of N bits, where producing the N symbols comprises producing a digital representation of a first symbol having a time period T based upon a first bit of the series of N bits, producing a digital representation of a second symbol having a time period T based upon a second bit of the series of N bits where the second symbol is time delayed by a period of T/N relative to the first symbol, and producing a digital representation of a third symbol having a time period T based upon a third bit of the series of N bits where the third symbol is time delayed by a period of T/N relative to the second symbol; summing each of the N symbols at each T/N time interval during the symbol time period T of the first symbol to produce a series of summed values; producing an analog waveform based upon the series of summed values; and generating a signal on a communication channel based upon the analog waveform.

In still another embodiment, a method of receiving data transmitted via time shift (TS) signaling comprises receiving an analog signal via a communication channel; sampling the analog signal using N sample and hold circuits that are each delayed from each other by a time period T/N; digitizing outputs of the N sample and hold circuits using N analog-to-digital converters (ADCs); equalizing outputs of the N ADCs using N receiver equalizers; processing outputs of the N receiver equalizers using a TS Inter-Symbol Interference (ISI) canceller and a Decision Feedback Equalizer (DFE) equalizer, wherein the TS ISI canceller and DFE equalizer utilizes samples at intervals of N/T from each of the outputs provided by the N receiver equalizers to generate output symbols; and decoding the output symbols to generate a series of recovered bits.

In a yet further embodiment, a method of communicating via time shift (TS) signaling comprises receiving a series of N bits from a serializer-deserializer (SERDES) circuit; producing N symbols based upon the series of N bits; summing each of the N symbols at each T/N time interval during the symbol time period T of the first symbol to produce a series of summed values; producing an analog waveform based upon the series of summed values; transmitting a signal on a communication channel based upon the analog waveform; receiving the signal via the communication channel; sampling the received signal using N sample and hold circuits that are each delayed from each other by a time period T/N; digitizing outputs of the N sample and hold circuits using N analog-to-digital converters (ADCs); equalizing outputs of the N ADCs using N receiver equalizers; processing outputs of the N receiver equalizers using a TS Inter-Symbol Interference (ISI) canceller and a Decision Feedback Equalizer (DFE) equalizer to generate output symbols; and decoding the output symbols to generate a series of recovered bits.

In yet another embodiment, a method of encoding data for transmission via time shift signaling comprises receiving N bits; generating a symbol of period T with respect to each of the N bits, wherein each sequential symbol is time delayed by T/N; summing the time delayed symbols, wherein the sum is equal to a number of superimposed symbols sharing a same binary value; providing the sum to a digital-to-analog converter; and providing an output of the digital-to-analog converter to a linear driver to generate a transmitted analog signal.

In a further additional embodiment, N is equal to 2, and the sum has three possible levels encoding the two bits.

In another additional embodiment, zero 1s results in the sum equaling 0, one 1 and one 0 results in the sum equaling 1, and two 1s results in the sum equaling 2.

In a still yet further embodiment, a method of decoding data received via time shift signaling comprises receiving an analog signal transmitted via time shift signaling; digitizing time delayed versions of the received analog signal; and performing inter-symbol interference (ISI) cancellation to estimate each of time shifted symbols.

In a still yet another embodiment, the time delayed versions of the received analog signal are delayed from each other by T/N, where T is a symbol period and N is a number of superimposed symbols.

In one further embodiment, a method of communicating via time shift signaling comprises receiving N bits; generating a symbol of period T with respect to each of the N bits, wherein each sequential symbol is time delayed by T/N; summing the time delayed symbols, wherein the sum is equal to a number of superimposed symbols sharing a same binary value; providing the sum to a digital-to-analog converter; providing an output of the digital-to-analog converter to a linear driver to generate a transmitted analog signal; receiving the transmitted analog signal via a communication channel; digitizing time delayed versions of the received analog signal; and performing inter-symbol interference (ISI) cancellation to estimate each of time shifted symbols.

In one additional embodiment, a transmitter is configured to perform the method of transmitting data via time shift signaling.

In one other embodiment, a receiver is configured to perform the method of receiving data transmitted via time shift signaling.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIG. 1 illustrates a communication system in which two integrated circuits communicate using linear transceivers via TS signaling in accordance with an embodiment of the invention.

FIG. 2 illustrates a linear transceiver capable of transmitting and receiving data using TS signaling in accordance with an embodiment of the invention.

FIG. 3 illustrates a TS encoder in accordance with an embodiment of the invention.

FIGS. 4A and 4B conceptually illustrate a digital sum of time delay signals produced by two bitreams using TS3 signaling in accordance with an embodiment of the invention.

FIG. 5 illustrates TS receiver capable of receiving a TS signal and decoding a bitstream in accordance with an embodiment of the invention.

FIG. 6A-6F show simulations of signals generated based upon dividing a bitstream into a first bitstream and a second bitstream and using the bitsreams to generate a TS signal, which is then decoded using various processes in accordance with embodiments of the invention.

### DETAILED DESCRIPTION

Turning now to the drawings, systems and methods for communicating using time shift (TS) signaling are disclosed. In many communication systems, modulation techniques are utilized in which binary signals are either transmitted individually (e.g. NRZ) or grouped together to generate a symbol with an amplitude and/or phase that is determined based upon the value of the multiple grouped bits (e.g. PAM4, PAM-N, QAM, PSK-N). Systems and methods in accordance with many embodiments of the invention employ TS signaling in which each bit corresponds to a symbol having a time period T. At any given time, the transmitted signal is the superposition of N symbols. The superposition of the N symbols is achieved, because each of the N symbols of period T is transmitted sequentially with spacing of T/N between consecutive bits. In this way, systems and methods in accordance with various embodiments of the invention can transmit N bits per time interval T using a signal having N+1 voltage levels. By contrast, a system utilizing PAM requires 2^{N} voltage levels to transmit the same number of bits at a baud rate of 1/T symbols per second. TS signaling allows trading off timing information for bits per symbol in a linear fashion. Compared to PAM, TS signaling utilizes a lower transmission bandwidth for a given data rate or can achieve a higher data rate at a given bandwidth. While much of the discussion that follows relates to the use of TS signaling in one dimension, TS signaling is not limited to use in combination with amplitude modulation and can be utilized in combination with multi-dimensional modulation schemes including (but not limited to) Quadrature Amplitude Modulation (QAM) and Phase Shift Keying (PSK).

Systems and methods for communicating using TS signaling in accordance with various embodiments of the invention are discussed further below.

### Communication Systems that Utilize TS Signaling

In many embodiments, TS signaling is implemented within a linear transceiver within an integrated circuit. In several embodiments, a TS signaling transmitter is implemented using a binary to time-shift encoder configured to receive N bits and generate a symbol of period T with respect to each of the bits. Each sequential symbol is time delayed by T/N and the resulting symbols are summed. The sum can be considered to be equal to the number of the superimposed symbols that correspond to a binary value of 1. In the example of TS-2, zero 1s will result in the sum equaling 0. One 1 and one 0 will result in the sum equaling 1 and two 1s will result in the sum equaling 2. In this way, three levels encode the two bits instead of the four levels of PAM4. The sum can then be provided to a digital-to-analog converter and the output provided to a linear driver to generate the transmitted analog signal. In a number of embodiments, a TS decoder is implemented by digitizing time delayed versions of the received signal and then performing ISI cancellation to estimate each of the time shifted symbols.

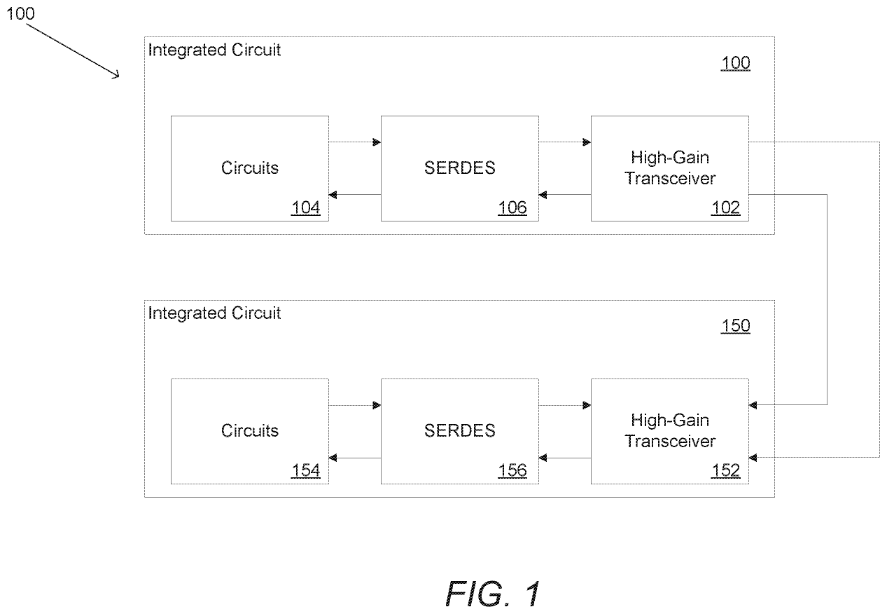

A communication system in which two integrated circuits communicate using linear transceivers via TS signaling in accordance with an embodiment of the invention is illustrated in FIG. 1. The communication system 100 includes two integrated circuits 100, 150 that communication via linear transceivers 102 and 152 using TS signaling. The first integrated circuit 100 may include circuits 104 that couple to serializer-deserializer (SERDES) circuit 106. The SERDES circuit 106 may transmit and receive parallel data to and from circuits 104. The SERDES 106 may transmit and receive high-speed serial data to and from high-speed transceiver 102.

The linear transceiver 102 may transmit and receive serial data to and from linear transceiver 152 in integrated circuit 150 using TS signaling. The linear transceiver 152 may similarly transmit and receive serial data to and from SERDES circuit 156, which may transmit and receive parallel data to and from circuits 154 within the second integrated circuit 150.

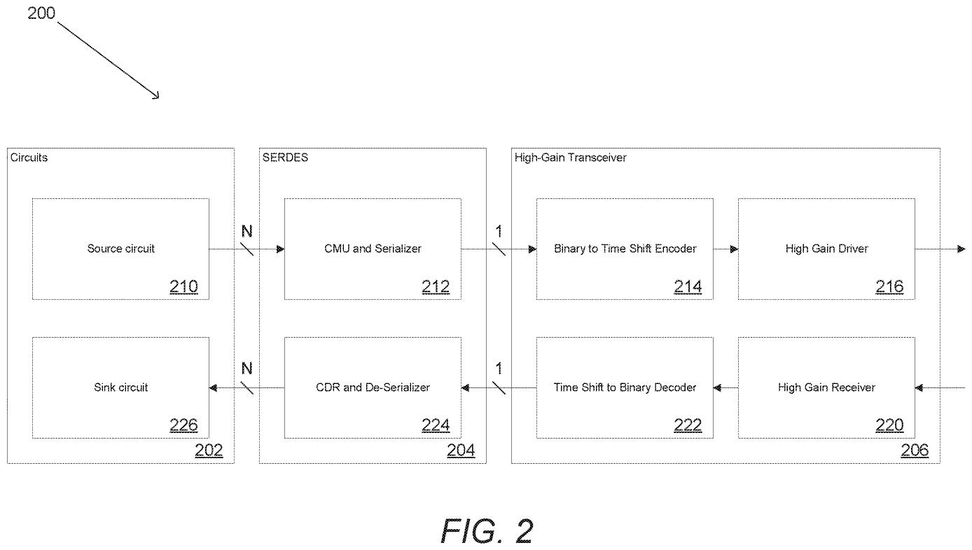

In a number of embodiments, the linear transceivers 102 and 152 can include encoders and decoders, as well as drivers and receiver circuits. The linear transceivers 102 and 152 can receive high-speed binary data, and encode the data for improved transmission. These transceivers may also receive encoded data and decode the data to high-speed binary data. Examples of linear transceivers that can be utilized in communication systems similar to those described with reference to FIG. 1 are discussed further below with reference to FIGS. 2, 3 and 5.

The signal path between the integrated circuits 100, 150 can be single-ended or differential. Further, this single-ended or differential signal path may be DC or directly coupled or these paths may be AC coupled through capacitors. These connections may be formed using conductive wires such as copper, or fiber optics, or other suitable media. These connections may also be wireless, they may rely on capacitive or inductive coupling, or they may be other types of connections.

While integrated circuits 100 and 150 are shown as having similar topologies, in many embodiments of the present invention, integrated circuits having different topologies can communicate via linear transceivers using TS signaling. As can readily be appreciated, integrated circuits similar to those illustrated in FIG. 1 may include circuits that are incorporated within servers, memories, switches, routers, transport equipment, and/or other types of devices that are employed in data communication systems.

In a number of embodiments, integrated circuits such as those shown in FIG. 1 can be implemented using Complementary Metal-Oxide-Semiconductor (CMOS) processes, in other embodiments of the present invention, integrated circuits are utilized that are formed using Bipolar, Bipolar-Complementary Metal-Oxide-Semiconductor (BiCMOS), High Electron Mobility Transistor (HEMT), Pseudomorphic High-Electron-Mobility Transistor (pHEMT), Heterojunction Bipolar Transistor (HBT), Metal Semiconductor Field Effect Transistor (MESFET), and/or one or more additional manufacturing processes that are appropriate to the requirements of specific applications.

Furthermore, while the integrated circuits shown in FIG. 1 include linear transceivers, it should be readily appreciated that integrated circuits can also communicate using TS signaling, where one of integrated circuits incorporates a receiver, and the other integrated circuit incorporates a transmitter.

### Linear Transceivers that Utilize TS Signaling

Linear transceivers in accordance with various embodiments of the invention include TS encoders that encode high speed binary data to produce a TS signal and TS decoders that receive TS signals and output high speed binary data.

An integrated circuit incorporating a linear transceiver capable of transmitting and receiving data using TS signaling in accordance with an embodiment of the invention is illustrated in FIG. 2. The integrated circuit 200 illustrated in FIG. 2 can be utilized in any of a variety of communication systems including those described above with reference to FIG. 1. The function of the integrated circuit is determined by the nature of the circuits 202, 226.

The integrated circuit 200 includes circuits 202 that transmit and receive parallel data to and from a SERDES 204. The SERDES is capable of transmitting and receiving serial data to and from a linear transceiver 206.

Within the transmit path, a first serializer 212 within the SERDES 204 can receive parallel data from circuit 210 and provide binary data to a TS encoder 214 within the linear transceiver 206. The TS encoder 214 can provide encoded data to a linear driver 216, which can in turn transmit the encoded data. In many embodiments, the TS encoder 214 is capable of operating in a linear state such that it can drive the encoded data without the need for separate linear driver 216, or a linear driver can be part of TS encoder 214.

With respect to the receive path, the integrated circuit 200 can receive high speed data transmitted using TS signaling via a linear receiver 220. The linear receiver 220 can provide the received signal to a TS decoder 222. The TS decoder 222 can decode the data and provide it to a deserializer 224. The deserializer 224 is capable of receiving serial binary data and can parallelize the data to provide parallel data to circuit 226.

While specific linear transceiver architectures are described above, any of a variety of transceiver architectures can be utilized that support the encoding and transmission of data using TS signaling and/or the reception and decoding of data transmitted using TS signaling as appropriate to the requirements of specific applications in accordance with various embodiments of the invention. Various TS encoder and TS decoder implementations that can be utilized in: integrated circuits, including (but not limited to) the integrated circuits shown in FIG. 1; linear transceivers, including (but not limited to) the linear transceivers discussed above with reference to FIG. 2; linear transmitters; and linear receivers in accordance with various embodiments of the invention are discussed further below.

### TS Encoders

TS encoders in accordance with various embodiments of the invention are capable of taking a series of bits and producing TS signals for transmission via a communication channel. In many embodiments, each bit is used to generate a symbol and each symbol in the resulting series of signals is delayed relative to the previous symbol in the series by a fraction of the symbol time period. The time delayed signals are then summed and the resulting superposition of the time delayed symbols used to generate an analog waveform that is transmitted via the channel.

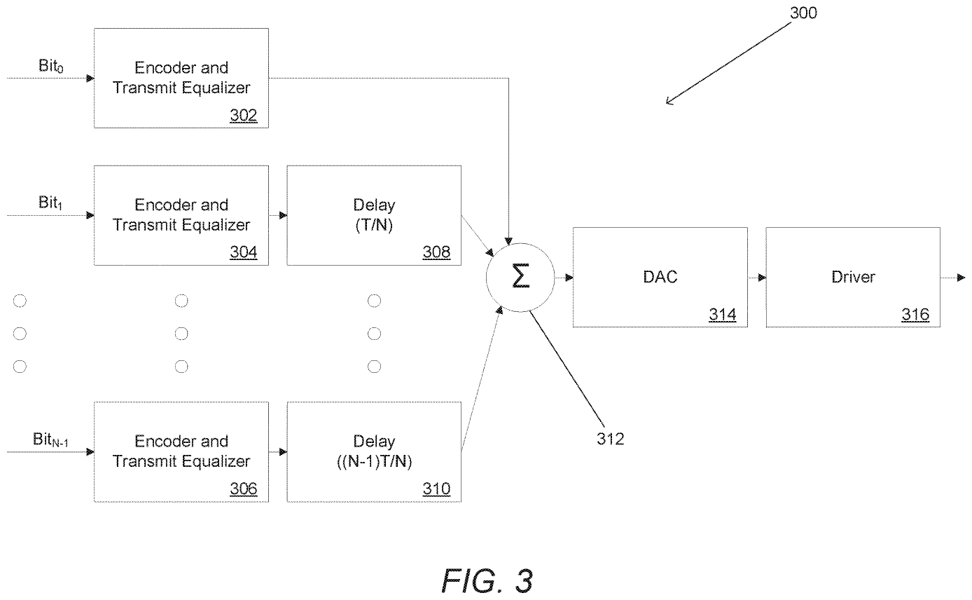

A TS encoder in accordance with an embodiment of the invention is illustrated in FIG. 3. The TS encoder 300 is capable of being utilized in any of the integrated circuits including (but not limited to) the integrated circuits described above with reference to FIG. 1 and/or high-speed transceivers including (but not limited to) the high-speed transceivers described above with reference to FIG. 2.

The TS encoder 300 receives a series of N bits B₀, B₁, . . . , B_{N-1}. Each bit is provided to a separate encoder and transmit equalizer 302, 304, 306, which produces a digital representation of a symbol having time period T. A first encoder and transmit equalizer 302 receives a first bit (B₀) of the N bit series and produces a representation of a first symbol S₀. A second encoder and transmit equalizer 304 receives a second bit (B₁) of the N bit series and produces a representation of a second symbol S₁ that is provided to a time delay 308. The time delay 308 delays the symbol generated by the second encoder and transmit equalizer 304 by a time delay of T/N. Each successive bit (Bᵢ) in the N bit series is similarly provided to an encoder and time delay equalizer to produce a representation of a symbol Sᵢ that is then delayed using a time delay by an additional incremental delay of T/N such that the symbol Sᵢ corresponding to each bit Bᵢ is delayed by an amount i(N/T). The final bit in the N bit series is provided to an N^{th} encoder and transmit equalizer 306 produces a representation of an Nth symbol that is provided to an (N−1)^{th} time delay 310. The time delay 310 delays the N^{th} symbol by a delay of (N−1)T/N.

The N symbols output by the first encoder and transmit equalizer 302 and the N−1 time delays 308, 310 are summed (312) at each T/N time interval during the symbol time T. The sums are provided to a digital-to-analog converter (DAC) 314, which produces an analog waveform based upon the series of summed values. The analog waveform is then provided to a driver 316, which utilizes the analog waveform to generate a signal on a communication channel.

At the end of the time period T, a new series of bits is provided as inputs to the encoders and transmit equalizers 302, 304, 306. At time T+N/T, the sum (312) provided to the DAC 314 is the sum of the digital representations of the time delayed versions of symbols S₁, . . . , S_{N-1} and the newly generated representation of symbol S_{N}, which is based upon bit B_{N} (i.e. the N+1ₜₕ bit in the series). At each additional time increment of N/T the sum of the symbols adds a contribution from the next bit in the series and removes a contribution from a bit in the series. In many ways, the superposition of symbols can be considered a sliding window including contributions from N bits in the series at each N/T time increment.

While specific components of TS encoders are described above with reference to FIG. 3, it should be readily appreciated that the generation of symbol waveforms and time delays is performed in the digital domain and that any of a variety of other techniques can be utilized to generate a digital representation of a superposition of time delayed signals as appropriate to the requirements of specific applications in accordance with certain embodiments of the invention. For example, TS encoders in accordance with many embodiments of the invention pre-compute values and utilize a lookup table or a state machine in combination with a plurality of lookup tables to generate the digital values that are provided to a DAC to generate a TS signal. Accordingly, TS encoders should be understood as not limited to any specific implementation and that any of a variety of different TS encoder implementations capable of generating a TS signal having N+1 possible levels that is the superposition of N time shifted symbols can be utilized in integrated circuits, linear transceivers, linear transmitters, in accordance with various embodiments of the invention. Specific examples of the manner in which a series of bits can be encoded to produce TS signals in accordance with various embodiments of the invention are discussed further below.

### TS Transmitter

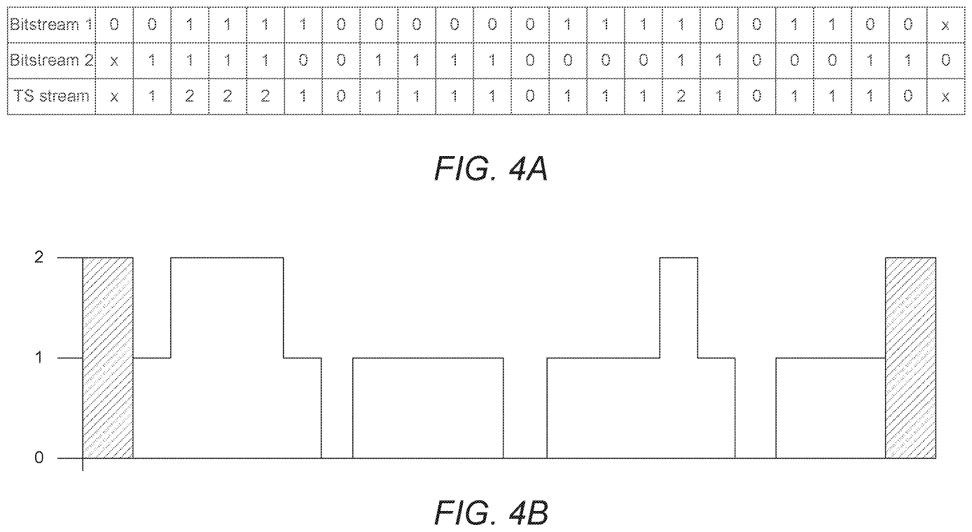

Referring now to FIGS. 4A and 4B, a digital sum of time delay signals produced by two bitreams using TS3 signaling in accordance with an embodiment of the invention is conceptually illustrated. During each time interval T/N, a value for the TS stream is produced by summing the values of the bits in Bitstream 1 and Bitstream 2. The example shown in FIGS. 4A and 4B is intentionally simple to illustrate the underlying principles of TS signaling. As can readily be appreciated, real-world implementations of TS signaling can be significantly more complex. For example, many TS signaling schemes involve producing symbols for each of the bitstreams that are equalized to account for channel impairments. In several embodiments, each bitstream is equalized at the transmitter for a given channel as if the bitstream was an independent single channel. When combined, the resulting signal at the transmitter is the sum of all individual channels. The specific manner in which the symbols that are time delayed and superimposed are generated based upon a bitstream within a TS encoder is largely dependent upon the nature of the channel and the requirements of specific applications. Various approaches to decoding TS signals using TS decoders in accordance with different embodiments of the invention are discussed further below.

### TS Receiver

A TS receiver in accordance with many embodiments of the invention can receive a transmitted analog signal that is sampled by N sample and holds circuits that are delayed from each other by T/N. Depending on the impairments of the channel, the received signals may require equalization before being processed by the TS ISI canceller. In the case of benign channels, this equalization may be accomplished by processing the signals in the analog domain. In the case of severe channels (large ISI and reflection) the output of each of the N sample and hold circuits are provided to separate ADCs, which are followed by N digital equalizers which remove the ISI introduced by the channel on both the desired bit stream as well as the undesired bit streams. The resulting bit streams can then be processed by the TS ISI canceller to remove the undesired ISI and produce the desired bit stream. A Decision Feedback Equalizer (DFE) and a Maximum Likelihood Sequence Estimator (MLSE) can be used to further equalize and decode the desired signal. In the case of moderately severe channels, DFE and MLSE blocks may not be required. By treating each symbol as being transmitted in the presence of ISI in this way, the receiver can recover each of the superimposed time delay signals separately and utilize the recovered symbols to recover the transmitted bitstream. The cardinality of the received time delay signals reflects the number of superimposed symbols+1. Accordingly, TS3 includes two superimposed symbols, TS4 includes three superimposed symbols, etc.

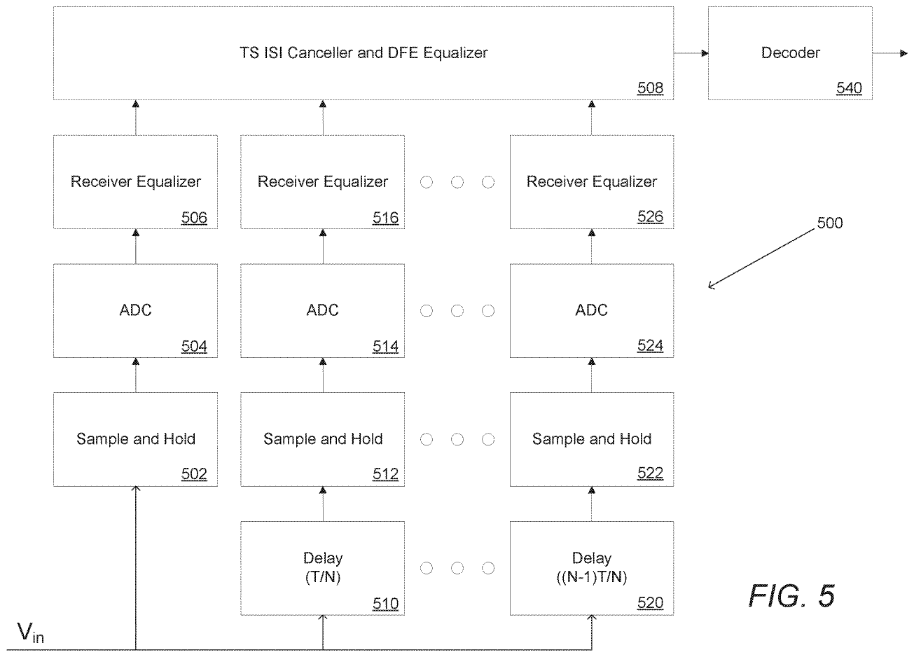

A TS receiver capable of receiving a TS signal and decoding a bitstream in accordance with an embodiment of the invention is conceptually illustrated in FIG. 5. The TS receiver 500 shown in FIG. 5 can be utilized in integrated circuits, including any of the integrated circuits described above with reference to FIG. 1, linear transceivers, including the linear transceivers described above with respect to FIG. 2, linear receivers, and in a communication system in combination with TS transmitter, including any of the TS transmitter described above with respect to FIG. 3.

The TS receiver 500 receives an analog input signal Vᵢₙ. The signal is initially sampled and digitized using a first sample and hold circuit 502 and a first analog-to-digital converter (ADC) 504. The output of the first ADC 504 is then provided to a receiver equalizer 506, which is a digital equalizer that removes the ISI and reflections introduced by the channel. The output of the first equalizer is then provided to the TS ISI Canceller and DFE Equalizer 508, which is responsible for generating an output signal at each time interval N/T. The TS ISI Canceller and DFE Equalizer 508 utilizes samples at intervals of N/T over a symbol time period T to generate an output signal corresponding to one of a plurality of superimposed symbols transmitted via TS signaling.

Time delayed samples of the input signal can be obtained by the TS ISI Canceller and DFE Equalizer 508 using N−1 time delays 510, 520. The time delayed samples are obtained by applying a time delay to the received signal Vᵢₙ using a time delay 510, 520. The time delayed signal is then digitized using sample and hold circuitry 512, 522 and an ADC 514, 524. The digital output of the ADC can be provided to a receiver equalizer 516, 526, which removes the ISI or reflections introduced by the channel. The outputs of the receiver equalizers 506, 516, and 526 corresponding to samples of Vᵢₙ taken at Tᵢ+(N−1)T/N, . . . , Tᵢ+T/N, Tᵢ are then provided to the TS ISI Canceller and DFE Equalizer 508. In the case of benign channels, equalization may be performed entirely in the analog domain. In the case of moderately or severe impaired channels DFE and MLSE may be utilized.

The TS ISI Canceller and DFE Equalizer 508 receives digital values obtained using samples of the received analog signal over a time period T, where the N/T samples are taken at regular intervals from time Tᵢ to Tᵢ+(N−1)/T. The received analog signal is the superposition of time shifted symbols and the TS ISI Canceller and DFE Equalizer 508 extracts the symbol that was transmitted at time Tᵢ having a symbol duration of time T from the T/N received values by treating the contributions of the additional N−1 superimposed symbols as ISI. In many embodiments, the TS ISI Canceller and DFE Equalizer 508 can also use a DFE to account for channel impairments.

At each time interval T/N, the TS ISI Canceller and DFE Equalizer 508 outputs a symbol to a decoder 540 and the decoder recovers a bit corresponding to the symbol output by the TS ISI Canceller and DFE Equalizer 508 and outputs the recovered bit as part of a decoded bitstream.

While specific architectures for TS receivers are described above with respect to FIG. 5, it should be readily appreciated that the recovery of the received symbols is performed in the digital domain and that any of a variety of other techniques can be utilized to sample a received signal and recover time shifted symbols for decoding. Accordingly, TS decoders should be understood as not limited to any specific implementations capable of generating a bitstream from a received TS signal having N+1 possible levels that is the superposition of N time shifted symbols can be utilized in integrated circuits, linear transceivers, linear transmitters, in accordance with various embodiments of the invention. Specific simulations involving the use of TS signaling to communicate a series of bits in accordance with various embodiments of the invention are discussed further below.

### TS3 Signaling Simulations

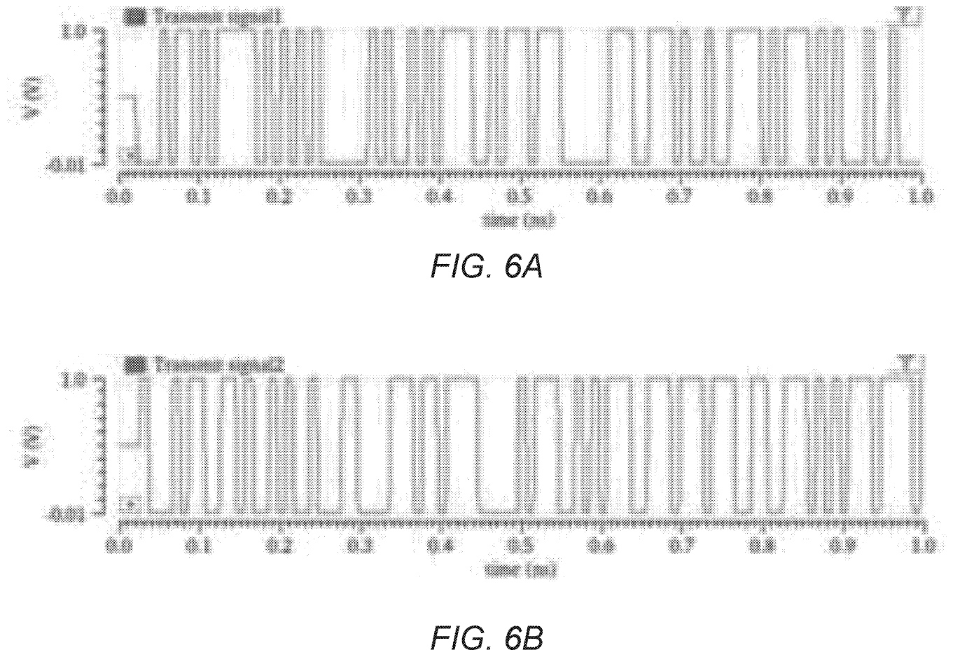

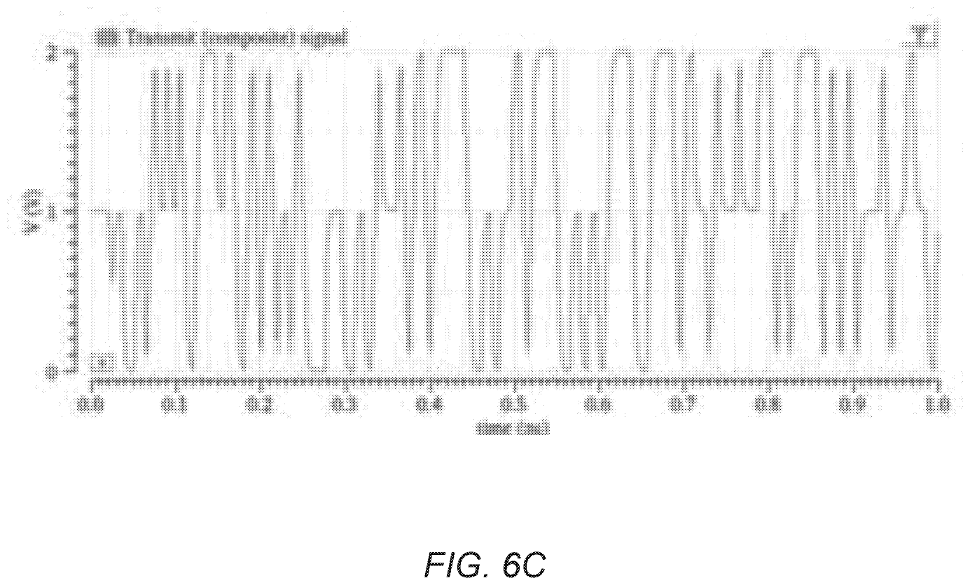

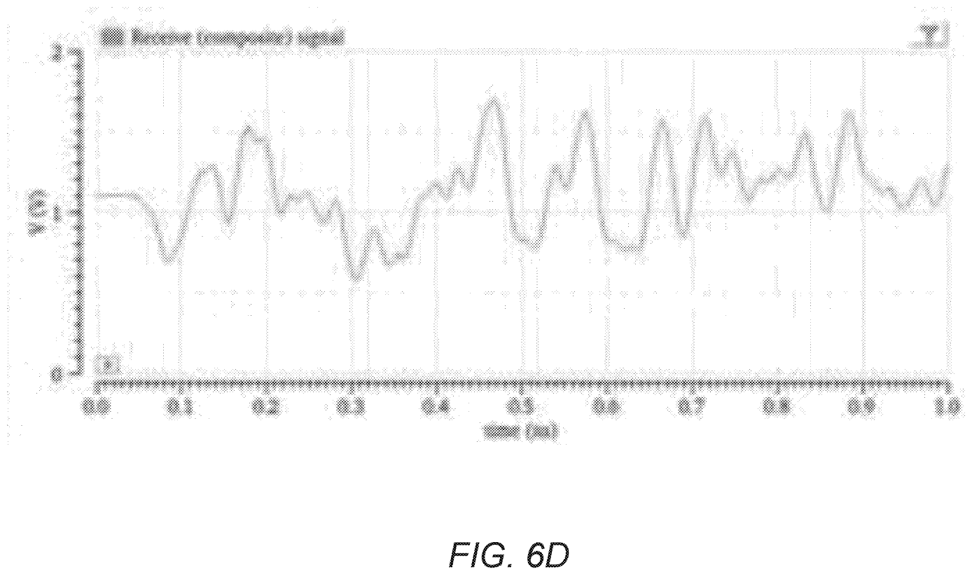

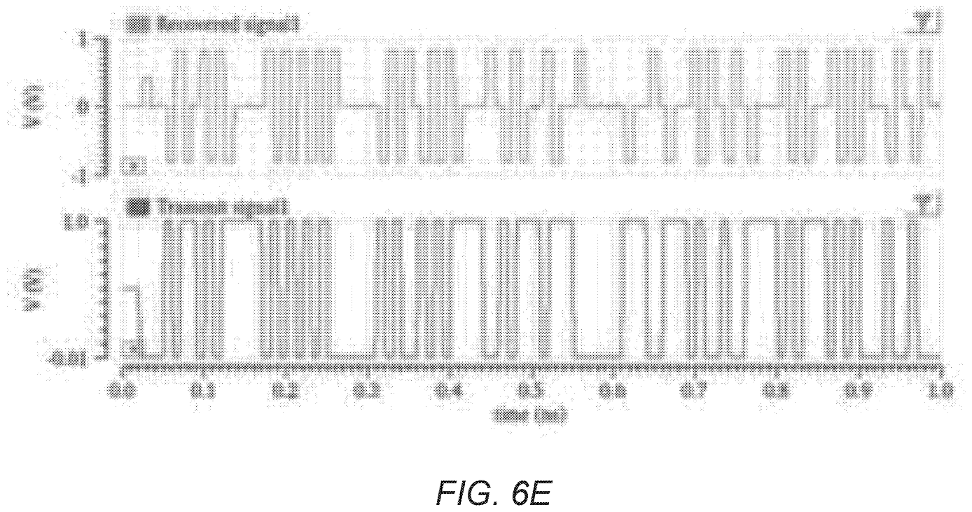

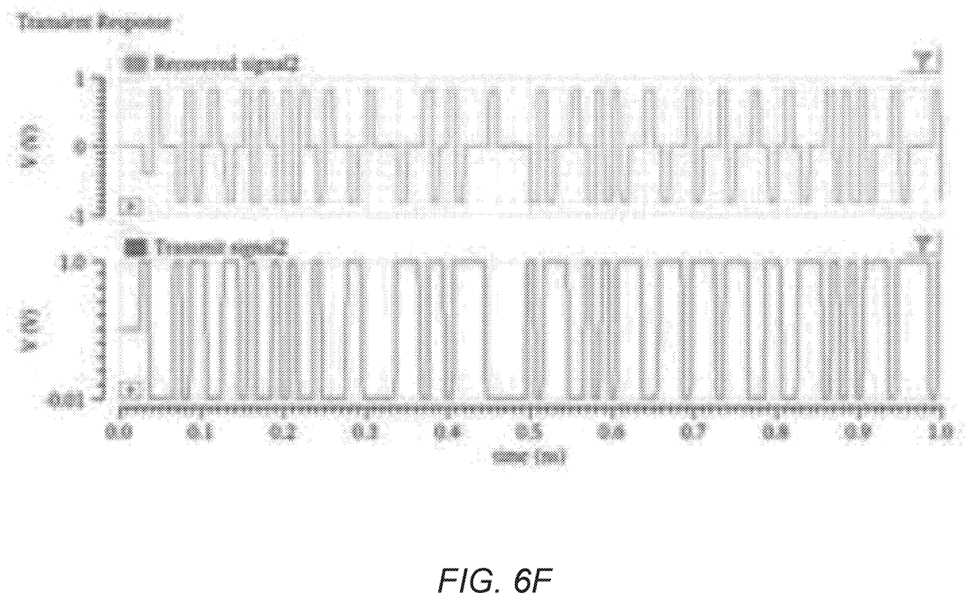

Referring now to FIG. 6A-6F simulations of signals generated based upon dividing a bitstream into a first bitstream and a second bitstream and using the bitsreams to generate a TS signal, which is then decoded, using processes similar to those described above in accordance with embodiments of the invention are illustrated. The simulation results illustrate the TS transmit signal, received signal and recovered signal for a benign channel. This simulation was performed with real circuits and a real channel model confirming one example of an end-to-end realization of a communication system in accordance with an embodiment of the invention.

While specific systems and methods are described above for performing TS signaling, the inventions described herein are not limited to any of the specific examples that are described. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A transmitter capable of communicating via time shift signaling, comprising:
interface circuitry capable of receiving data from a serializer-deserializer (SERDES) circuit;
a TS encoder capable of receiving a series of N bits (B₀, B₁, . . . , B_{N-1}) from the interface circuitry, where the TS encoder comprises:
a plurality of separate encoder and transmit equalizer, where:
each bit is provided to one of the plurality of separate encoder and transmit equalizers to produce N symbols based upon the series of N bits; and
the plurality of separate encoder and transmit equalizers include at least:
a first encoder and transmit equalizer capable of producing a digital representation of a first symbol (S₀) having a time period T based upon a first bit (B₀) of the series of N bits;
a second encoder and transmit equalizer capable of producing a digital representation of a second symbol (S₁) having a time period T based upon a second bit (B₁) of the series of N bits, where the second symbol is time delayed by a period of T/N relative to the first symbol; and
a third encoder and transmit equalizer capable of producing a digital representation of a third symbol (S₂) having a time period T based upon a third bit (B₂) of the series of N bits, where the third symbol is time delayed by a period of T/N relative to the second symbol;
a summing circuit capable of summing each of the N symbols output by the separate encoder and transmit equalizers at each T/N time interval during the symbol time period T of the first symbol (S₀) to produce a series of summed values;
a digital-to-analog converter capable of producing an analog waveform based upon the series of summed values; and
a driver circuit capable of generating a signal on a communication channel based upon the analog waveform.

2. The transmitter of claim 1, wherein the communication channel is single-ended or differential.

3. The transmitter of claim 2, wherein the communication channel is DC coupled or AC coupled through capacitors.

4. The transmitter of claim 1, wherein the communication channel comprises at least one of conductive wires, fiber optics, and a wireless connection.

5. The transmitter of claim 1, wherein the plurality of separate encoder and transmit equalizers further includes a fourth encoder and transmit equalizer capable of producing a digital representation of a fourth symbol (S₃) having a time period T based upon a fourth bit (B₃) of the series of N bits, where the fourth symbol is time delayed by a period of T/N relative to the third symbol.

6. The transmitter of claim 1, wherein each of the plurality of separate encoder and transmit equalizers is configured to equalize its respective bitstream for a given channel as if the bitstream was an independent single channel.

7. The transmitter of claim 1, wherein the analog waveform has N+1 possible voltage levels, where N bits are transmitted per time interval T.

8. The transmitter of claim 1, wherein, at the end of the symbol time period T of the first symbol (S₀), a new series of bits is provided as inputs to the encoder and transmit equalizers, and wherein at time T+T/N, the sum provided to the digital-to-analog converter is the sum of the digital representations of the time delayed versions of symbols S₁, . . . , S_{N-1} and a newly generated representation of symbol S_{N} based upon bit B_{N}, excluding the contribution from symbol S₀.

9. A receiver capable of receiving data transmitted via time shift (TS) signaling, comprising:
interface circuitry capable of transmitting data to a serializer-deserializer (SERDES) circuit;
a TS decoder capable of receiving an analog signal via a communication channel and outputting a series of recovered bits to the interface circuitry, where the TS decoder comprises:
N sample and hold circuits that are each delayed from each other by a time period T/N;
N analog-to-digital converters (ADCs), where each of the N sample and hold circuits is capable of providing an output to a corresponding ADC;
N receiver equalizers, where each of the N ADCs is capable of providing an output to a corresponding receiver equalizer;
a TS Inter-Symbol Interference (ISI) canceller and a Decision Feedback Equalizer (DFE) equalizer, where:
each of the N receiver equalizers provides an output to the TS ISI canceller and DFE equalizer; and
the TS ISI canceller and DFE equalizer utilizes samples at intervals of N/T from each of the outputs provided by the N receiver equalizers to generate output symbols; and
a decoder, where:
the TS ISI canceller and DFE equalizer is capable of providing the generated output symbols to the decoder; and
the decoder generates the series of recovered bits based upon the provided output symbols.

10. The receiver of claim 9, wherein the communication channel is single-ended or differential.

11. The receiver of claim 10, wherein the communication channel is DC coupled or AC coupled through capacitors.

12. The receiver of claim 9, wherein the communication channel comprises conductive wires, fiber optics, or a wireless connection.

13. The receiver of claim 9, wherein the N receiver equalizers are digital equalizers that remove ISI and reflections introduced by the communication channel.

14. The receiver of claim 9, wherein, depending on impairments of the communication channel, the received analog signal requires equalization before being processed by the TS ISI canceller.

15. The receiver of claim 14, wherein for benign channels, equalization is accomplished by processing signals in the analog domain.

16. The receiver of claim 14, wherein for severe channels having large ISI and reflection, the output of each of the N sample and hold circuits is provided to a separate ADC, followed by N digital equalizers which remove the ISI introduced by the channel.

17. The receiver of claim 9, wherein the analog signal has N+1 possible voltage levels, where N bits are transmitted per time interval T.

18. An integrated circuit capable of communicating via time shift (TS) signaling comprising:
a serializer-deserializer (SERDES) circuit;
circuits coupled to the SERDES circuit, where the SERDES is capable of transmitting and receiving parallel data to and from the circuits coupled to the SERDES circuit; a linear transceiver, where the linear transceiver is capable of transmitting and receiving high-speed serial data to and from the SERDES circuit;
wherein the linear transceiver comprises:
interface circuitry capable of transmitting and receiving data to and from the serializer-deserializer (SERDES) circuit;
a TS encoder capable of receiving a series of N bits (B₀, B₁, . . . , B_{N-1}) from the interface circuitry, where the TS encoder comprises:
a plurality of separate encoder and transmit equalizer, where:
each bit is provided to one of the plurality of separate encoder and transmit equalizers to produce N symbols based upon the series of N bits; and
the plurality of separate encoder and transmit equalizers include at least: a first encoder and transmit equalizer capable of producing a digital representation of a first symbol (S₀) having a time period T based upon a first bit (B₀) of the series of N bits; a second encoder and transmit equalizer capable of producing a digital representation of a second symbol (S₁) having a time period T based upon a second bit (B₁) of the series of N bits, where the second symbol is time delayed by a period of T/N relative to the first symbol; and a third encoder and transmit equalizer capable of producing a digital representation of a third symbol (S₂) having a time period T based upon a third bit (B₂) of the series of N bits, where the third symbol is time delayed by a period of T/N relative to the second symbol;
a summing circuit capable of summing each of the N symbols output by the separate encoder and transmit equalizers at each T/N time interval during the symbol time period T of the first symbol (S₀) to produce a series of summed values;
a digital-to-analog converter capable of producing an analog waveform based upon the series of summed values; and
a driver circuit capable of generating a signal on a first communication channel based upon the analog waveform;
a TS decoder capable of receiving an analog signal via a second communication channel and outputting a series of recovered bits to the interface circuitry, where the TS decoder comprises:
N sample and hold circuits that are each delayed from each other by a time period T/N;
N analog-to-digital converters (ADCs), where each of the N sample and hold circuits is capable of providing an output to a corresponding ADC;
N receiver equalizers, where each of the N ADCs is capable of providing an output to a corresponding receiver equalizer;
a TS Inter-Symbol Interference (ISI) canceller and a Decision Feedback Equalizer (DFE) equalizer, where:
each of the N receiver equalizers provides an output to the TS ISI canceller and DFE equalizer; and
the TS ISI canceller and DFE equalizer utilizes samples at intervals of N/T from each of the outputs provided by the N receiver equalizers to generate output symbols; and
a decoder, where:
the TS ISI canceller and DFE equalizer is capable of providing the generated output symbols to the decoder; and
the decoder generates the series of recovered bits based upon the provided output symbols.

19. The integrated circuit of claim 18, wherein the plurality of separate encoder and transmit equalizers further includes a fourth encoder and transmit equalizer capable of producing a digital representation of a fourth symbol (S₃) having a time period T based upon a fourth bit (B₃) of the series of N bits, where the fourth symbol is time delayed by a period of T/N relative to the third symbol.

20. The integrated circuit of claim 18, wherein, at the end of the symbol time period T of the first symbol (S₀), a new series of bits is provided as inputs to the encoder and transmit equalizers, and wherein at time T+T/N, the sum provided to the digital-to-analog converter is the sum of the digital representations of the time delayed versions of symbols S₁, . . . , S_{N-1} and a newly generated representation of symbol S_{N} based upon bit B_{N}, excluding the contribution from symbol S₀.
